(19) United States
(12) Patent Application Publication
(10) Pub. No.: US 2021/0101112 A1
(43) Pub. Date: Apr. 8, 2021

(54) ADSORBENT COMPOSITIONS FOR CARBON MONOXIDE REMOVAL

(71) Applicant: BASF Corporation, Florham Park, NJ (US)

(72) Inventors: Artem D. VITYUK, Iselin, NJ (US); Linda HRATKO, Iselin, NJ (US)

(21) Appl. No.: 16/971,090

(22) PCT Filed: Mar. 4, 2019
(86) PCT No.: PCT/US2019/020521

§ 371 Date: Aug. 19, 2020

Related U.S. Application Data
(60) Provisional application No. 62/638,612, filed on Mar. 5, 2018.

(51) Int. Cl. B01D 53/62; B01D 53/86; B01D 53/02; B01J 20/08; B01J 20/30

(52) U.S. Cl. CPC B01D 53/62; B01D 53/864; B01D 53/02; B01J 20/08; B01J 20/3007; B01J 20/3078; B01J 2220/42; B01D 2253/104; B01D 2255/20738; B01D 2255/20792; B01D 2255/20761; B01D 2257/502; B01D 2253/1124

(57) ABSTRACT

Adsorbent compositions comprising one or more copper oxides and one or more iron oxides are effective towards removing CO from process streams at temperatures below 100° C., for instance olefin process streams. A method of removing CO from a process stream comprises contacting the stream with the adsorbent composition comprising one or more copper oxides and one or more iron oxides.

### CROSS-REFERENCE TO RELATED APPLICATION(S)

This application claims the benefit of priority of U.S. Provisional Patent Application No. 62/638,612, filed on Mar. 5, 2018, the disclosure of which is hereby incorporated by reference herein in its entirety.

### FIELD OF THE DISCLOSURE

The present invention relates to adsorbent compositions and methods of removing carbon monoxide (CO) from process streams, for example, hydrocarbon process streams.

### BACKGROUND

Streams for use in a chemical process ideally contain essentially no impurities that might impede a desired chemical reaction. For example, olefin polymerization processes employ catalysts, such as metallocenes, which are susceptible to poisoning from only trace amounts of impurities in the olefin process feed stream. Accordingly, olefin feed streams for polymerization processes must contain no more than ppb (parts per billion) levels of impurities; these streams are termed “polymer grade” olefins. Olefins from typical sources including steam crackers, fluid catalytic crackers, dehydrogenations, MTO (methanol to olefins) processes, and the like usually contain much higher levels of undesired impurities such as CO or oxygen, for instance ppm (parts per million) or higher levels; these streams are termed “chemical grade” olefins.

Streams to be purified include air, nitrogen, argon, and hydrocarbons including olefins such as ethylene, propylene, 1-butene, 2-butene, 1,3-butadiene, or styrene. Adsorbents comprising copper oxide, zinc oxide, and alumina are employed to remove CO from olefin streams. These adsorbents require process temperatures of from about 90° C. to about 150° C. Desired are adsorbents effective to remove CO from process streams at lower temperatures.

### SUMMARY

Disclosed herein are adsorbent compositions capable of removing CO from process streams at temperatures below 100° C. In one aspect, an adsorbent composition comprises one or more copper oxides and one or more iron oxides.

In certain embodiments, a weight/weight ratio of the one or more copper oxides to the one or more iron oxides is from about 20/80 to about 80/20.

In certain embodiments, the composition comprises from about 0.2 wt % to about 99.8 wt % of the one or more copper oxides, based on the total weight of the composition. In certain embodiments, the composition comprises from about 0.2 wt % to about 99.8 wt % of the one or more iron oxides, based on the total weight of the composition.

In certain embodiments, the composition further comprises a support or a filler. In certain embodiments, the support or filler is selected from a group consisting of alumina, silica, magnesia, zirconia, aluminosilicates, clays, molecular sieves, activated carbons, and combinations thereof.

In certain embodiments, the composition further comprises from about 0.1 wt % to about 10.0 wt % ZnO, based on the total weight of the composition. In certain embodiments, the composition is essentially free of ZnO.

In certain embodiments, the composition further comprises one or more promoters selected from a group consisting of potassium, sodium, manganese, chromium, cobalt, tungsten, molybdenum, nickel, magnesium, and calcium. In certain embodiments, the one or more promoters are present from about 0.05 wt % to about 5.0 wt %, based on the total weight of the composition.

In certain embodiments, the composition is in a form selected from a group consisting of tablets, briquettes, rings, stars, wagon wheels, extrudates, rods, cylinders, and pellets.

In certain embodiments, the composition is in a form selected from a group consisting of tablets, briquettes, cylinders, and pellets, having an average largest diameter from about 1 mm to about 25 mm.

In certain embodiments, a CO removal efficiency of the composition is ≥1.5 times that of an adsorbent composition comprising 40 wt % CuO, 40 wt % ZnO, and 19.9 wt % alumina when a process stream comprising CO is contacted with the compositions at a temperature of about 30° C. under identical conditions.

In another aspect, a method for the preparation of the composition comprises: preparing a solution comprising copper and iron salts; precipitating solids from the solution; isolating and drying the solids; and calcining the dried solids.

In certain embodiments, the method further comprises subsequently shaping the dried, calcined solids.

In certain embodiments, the method further comprises shaping the dried solids prior to the calcining step.

In certain embodiments, the method further comprises: subsequently shaping the dried, calcined solids to form shaped solids; and calcining the shaped solids.

In certain embodiments, the calcination step or steps are carried out at a temperature of from about 250° C. to about 700° C., for a time period of from about 0.1 h to about 12 h.

In certain embodiments, the shaping comprises extrusion, tableting, or pelletization.

In certain embodiments, the method further comprises adding a support to the solution comprising the copper and the iron salts.

In another aspect, a method of removing CO from a gaseous or liquid process stream comprises contacting the stream with any of the aforementioned adsorbent compositions. In certain embodiments, the process stream is a hydrocarbon stream. In certain embodiments the process stream is an olefin stream. In certain embodiments the process stream is a propylene or ethylene stream.

In certain embodiments, the contacting is performed at a temperature of from about 0° C. to about 110° C. In certain embodiments, the contacting is performed at a pressure of from about 1 bar to about 80 bar.

In certain embodiments, a rate of flow of the gaseous process stream over the adsorbent composition during the contacting is from about 1000 h⁻¹ to about 5000 h⁻¹, and a rate of flow of the liquid process stream over the adsorbent composition is from about 1 h⁻¹ to about 10 h⁻¹.

In certain embodiments, the process steam is an olefin stream, and ≤1000 ppm by weight of the olefin is oxidized during the contacting.

In certain embodiments, a CO removal efficiency from the process stream at a contacting temperature of about 30° C. is ≥1.5 times that of an adsorbent composition comprising 40 wt % CuO, 40 wt % ZnO, and 19.9 wt % alumina under identical conditions. In certain embodiments, the adsorbent composition comprising the copper oxides and the iron oxides and the adsorbent composition comprising 40 wt % CuO, 40 wt %, ZnO and 19.9 wt % alumina are identically shaped.

### DETAILED DESCRIPTION

The adsorbent composition of the present invention comprises one or more copper oxides and one or more iron oxides. In certain embodiments, the copper oxides comprise CuO and the iron oxides comprise Fe₂O₃. In certain embodiments, a weight/weight ratio of the copper oxides to the iron oxides is from any of about 99.8/0.2, about 99.5/0.5, about 99/1, about 98/2, about 95/5 about 90/10, about 85/15, about 80/20, about 75/25, about 70/30, about 65/35, about 60/40, about 55/45, or about 50/50 to any of about 45/55, about 40/60, about 35/65, about 30/70, about 25/75, about 20/80, about 15/75, about 10/90, about 5/95, about 2/98, about 1/99, about 0.5/99.5, or about 0.2/99.8.

The composition may also comprise one or more of metallic (elemental) copper, metallic iron, iron carbonate hydroxide (Fe₂(OH)₂CO₃), copper carbonate hydroxide (Cu₂(OH)₂CO₃), Fe₃O₄, or Cu₂O. In certain embodiments, these other forms of copper and/or iron may be present in the adsorbent composition from any of about 0.02 wt % (weight percent), about 0.05 wt %, about 0.10 wt %, about 0.25 wt %, about 0.33 wt %, about 0.40 wt %, about 0.55 wt %, about 0.65 wt %, about 0.75 wt %, about 0.90 wt %, about 1.0 wt %, or about 1.5 wt % to any of about 2.0 wt %, about 2.5 wt %, about 3.0 wt %, about 3.5 wt %, about 4.0 wt %, about 4.5 wt %, or about 5.0 wt %, based on the total weight of the composition.

In certain embodiments, the adsorbent composition comprises from any of about 0.2 wt %, about 0.5 wt % (weight percent), about 0.7 wt %, about 1.0 wt %, about 2.5 wt %, about 4.0 wt %, about 5.0 wt %, about 6.0 wt %, about 8.0 wt %, about 10 wt %, about 12 wt %, about 15 wt %, about 20 wt %, about 25 wt %, or about 30 wt % to any of about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 96 wt %, about 97 wt %, about 98 wt %, about 99 wt %, or about 99.8 wt % copper oxides, based on the total weight of the composition.

In certain embodiments, the composition comprises from any of about 0.2 wt %, about 0.5 wt %, about 0.7 wt %, about 1.0 wt %, about 2.5 wt %, about 4.0 wt %, about 5.0 wt %, about 6.0 wt %, about 8.0 wt %, about 10 wt %, about 12 wt %, about 15 wt %, about 20 wt %, about 25 wt %, or about 30 wt % to any of about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 96 wt %, about 97 wt %, about 98 wt %, about 99 wt %, or about 99.8 wt % iron oxides, based on the total weight of the composition.

In certain embodiments, the adsorbent composition may consist essentially of or consist of CuO and Fe₂O₃ and one or more of metallic (elemental) copper, metallic iron, iron carbonate hydroxide (Fe₂(OH)₂CO₃), copper carbonate hydroxide (Cu₂(OH)₂CO₃), Fe₃O₄ and Cu₂O; or the composition may consist essentially of or consist of CuO and Fe₂O₃.

In certain embodiments, the composition may also comprise a support and/or filler. In certain embodiments, supports and fillers are selected from a group consisting of alumina, silica, magnesia, zirconia, aluminosilicates, clays, molecular sieves, activated carbons, and combinations thereof. In certain embodiments, the composition may comprise alumina and/or silica. A support and/or filler may be present from any of about 0.2 wt %, about 0.5 wt %, about 0.7 wt %, about 1.0 wt %, about 2.5 wt %, about 4.0 wt %, about 5.0 wt %, about 6.0 wt %, about 8.0 wt %, about 10 wt %, about 12 wt %, about 15 wt %, about 20 wt %, about 25 wt %, or about 30 wt % to any of about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 96 wt %, about 97 wt %, or about 98 wt %, based on the total weight of the composition.

In certain embodiments, the adsorbent composition may comprise ZnO, for example wherein ZnO is present from any of about 0.1 wt %, about 0.3 wt %, about 0.5 wt %, about 0.7 wt %, about 1.0 wt %, about 1.5 wt %, about 2.0 wt %, or about 2.5 wt % to any of about 3.0 wt %, about 3.5 wt %, about 4.0 wt %, about 4.5 wt %, about 5.0 wt %, about 5.5 wt %, about 6.0 wt %, about 6.5 wt %, about 7.0 wt %, about 7.5 wt %, about 8.0 wt %, about 8.5 wt %, about 9.0 wt %, about 9.5 wt %, or about 10.0 wt %, based on the total weight of the composition.

In certain embodiments, the adsorbent composition is essentially free of ZnO or contains no ZnO.

In certain embodiments, the adsorbent composition may comprise oxides of one or more promoters selected from a group consisting of potassium, sodium, cerium, manganese, chromium, cobalt, tungsten, molybdenum, nickel, magnesium, or calcium. In certain embodiments, one or more promoters may be present in the adsorbent composition from any of about 0.05 wt %, about 0.10 wt %, about 0.25 wt %, about 0.33 wt %, about 0.40 wt %, about 0.55 wt %, about 0.65 wt %, about 0.75 wt %, about 0.90 wt %, about 1.0 wt %, or about 1.5 wt % to any of about 2.0 wt %, about 2.5 wt %, about 3.0 wt %, about 3.5 wt %, about 4.0 wt %, about 4.5 wt %, or about 5.0 wt %, based on the total weight of the composition.

In certain embodiments, the adsorbent composition may comprise one or more promoters selected from manganese oxide, cobalt oxide, cerium oxide, or zirconium oxide.

The adsorbent composition may advantageously be in a shaped form, for example, a form selected from a group consisting of formed agglomerates, tablets, rings, stars, wagon wheels, extrudates, rods, cylinders, briquettes, and pellets. Tablets, briquettes, cylinders, and pellets may have an average largest diameter from any of about 1 mm, about 2 mm, about 3 mm, about 4 mm, about 5 mm, about 6 mm, about 7 mm, about 8 mm, about 9 mm, or about 10 mm to any of about 12 mm, about 14 mm, about 16 mm, about 18 mm, about 20 mm, about 22 mm, about 24 mm, or about 25 mm. Largest diameter means the largest measurement of a form. Shaped forms may be prepared from powders via processes including extrusion, palletization, or tableting.

In certain embodiments, the composition may be in a shaped form of tablets, briquettes, or extrudates having a largest diameter and length dimensions of any of about 1 mm, about 2 mm, about 3 mm, about 4 mm, or about 5 mm by any of about 1 mm, about 2 mm, about 3 mm, about 4 mm, or about 5 mm.

In certain embodiments, a CO removal efficiency from a process stream comprising CO, when the stream is contacted with the composition at a temperature of about 30° C., about 40° C., or about 50° C. is ≥1.5 times, ≥2.0 times, ≥2.5 times, ≥3.0 times, ≥3.5 times, ≥4.0 times, ≥4.5 times, ≥5.0 times, ≥5.5 times, or ≥6.0 times that of an adsorbent composition comprising 40 wt % CuO, 40 wt % ZnO, and 19.9 wt % alumina. In these comparisons, the contacting is at an identical time, temperature, pressure, and stream flow rate, and the adsorbent compositions are in an identical shaped form. A comparative adsorbent comprising 40 wt % CuO, 40 wt % ZnO, and 19.9 wt % alumina is disclosed for instance in Example 1 of U.S. Pat. No. 7,314,965.

The adsorbent compositions of the present invention may be prepared by a process comprising: preparation of a solution comprising copper and iron salts; precipitation of solids from the solution; isolation and drying of the solids; and calcination of the dried solids. The calcination step may be performed on the isolated, dried solids. In other embodiments, the isolated, dried solids may be shaped and the calcination step may be performed on the shaped adsorbent. In certain embodiments, the isolated dried solids may be calcined, the calcined solids may be shaped, and the shaped form may be further calcined (i.e., two calcination steps).

Suitable copper and iron salts include nitrates, halides, and sulfates. The copper and iron salts may have a same or different anion. In certain embodiments, the salt solution is heated to from any of about 30° C., about 35° C., about 40° C., or about 45° C. to any of about 50° C., about 55° C., about 60° C., about 65° C., about 70° C., or about 75° C.

Precipitation may be performed by adding a basic solution, for example, an alkali or alkali earth hydroxide, carbonate, or bicarbonate solution, such as sodium hydroxide or sodium carbonate. Precipitation may be carried at a temperature from any of about 30° C., about 35° C., about 40° C., or about 45° C. to any of about 50° C., about 55° C., about 60° C., about 65° C., about 70° C., or about 75° C. at a pH of below 7.0, for example, from about 5.8, about 6.0, about 6.2, or about 6.3 to about 6.5 or about 6.7. Precipitation may also be performed for a time period of from about 0.2 hours (h), about 0.3 h, about 0.4 h, about 0.5 h, about 0.7 h, about 1.0 h, or about 1.3 to any of about 1.5 h, about 1.7 h, about 1.9 h, about 2.1 h, about 2.3 h, about 2.5 h, about 3 h, about 4 h, or about 5 h.

After precipitation appears complete, the mixture may be allowed to “age” for a further time period at a temperature as described for the precipitation.

The solid precipitate may be isolated or collected by filtration or decantation, and is typically washed with DI (deionized) water to remove any water-soluble salts, such as sodium salts.

Drying of the isolated solids may be performed by heating to a temperature of from any of about 60° C., about 65° C., about 70° C., about 75° C., about 80° C., or about 90° C. to any of about 100° C., about 110° C., about 120° C., about 130° C., about 1400° C., or about 150° C. for a period of from any of about 0.1 h, about 0.25 h, about 0.4 h, about 0.5 h, about 0.75 h, about 1 h, about 1.5 h, about 2 h, or about 2.5 h to any of about 3 h, about 4 h, about 5 h, about 6 h, about 7 h, about 8 h, about 9 h, about 10 h, about 11 h, about 12 h, about 13 h, about 14 h, or about 15 h.

In other embodiments, the isolated precipitate may be spray-dried to form a powder.

In certain embodiments, the process comprises isolation and drying of the solids; calcination of the dried solids; and shaping of the dried, calcined solids.

In certain embodiments, the process comprises isolation and drying of the solids; shaping of the dried solids; and calcination of the dried, shaped solids.

In certain embodiments, the process comprises isolation and drying of the solids; calcination of the dried solids; shaping of the dried, calcined solids; and further calcination of the shaped solids.

That is to say, there is at least one calcination step, performed either on the isolated powder or on a shaped form. There may be two calcination steps, performed on the isolated powder and also on a shaped form.

In certain embodiments a calcination step or steps are carried out at a temperature of from any of about 250° C., about 300° C., about 350° C., or about 400° C. to any of about 450° C., about 500° C., about 550° C., about 600° C., about 650° C., or about 700° C., for a time period of from any of about 0.1 h, about 0.25 h, about 0.45 h, about 0.6 h, about 0.75 h, or about 1 h to any of about 1.5 h, about 2 h, about 2.5 h, about 3 h, about 4 h, about 5 h, about 6 h, about 7 h, about 8 h, about 9 h, about 10 h, about 11 h, or about 12 h.

In certain embodiments, a calcination step will be “mild,” for instance, at a temperature of from any of about 250° C., about 300° C., or about 350° C. to about 400° C. or about 450° C. Mild calcination may serve to prevent sintering and may result in the presence of a low level of residual iron carbonate hydroxide (Fe₂(OH)₂CO₃) and/or copper carbonate hydroxide in the final composition.

A shaping step may comprise extrusion, tableting or pelletization.

In certain embodiments, a support and/or filler may be added to the copper and iron salt solution. A support or filler may be added to a salt solution as a dispersion in water prior to a precipitation step. Supports or fillers may also be added to a solution as a non-dispersible solid or as a salt, for example aluminum nitrate.

In certain embodiments, a support or filler may be added either before or after precipitation of copper and iron salts.

If a support is present, the copper oxides and iron oxides may be impregnated in or deposited on the support.

In other embodiments, the adsorbent compositions may be prepared by simply physically mixing dry powders of one or more copper oxides, one or more iron oxides, and optionally one or more supports or fillers. The physical mixture may be shaped into a desired form such as a tablet, briquette, or extrudate.

Also subject of the present invention is a method of removing CO from a process stream, the method comprising contacting the stream with a present adsorbent composition. The process stream may be any composition from which removal of CO is desired. In certain embodiments, the process stream is a hydrocarbon stream, for example, an olefin stream. Olefin streams include for instance ethylene, propylene, 1-butene, 2-butene, 1,3-butadiene, or styrene.

Processes of the present invention may provide polymer grade olefin, for instance, may provide polymer grade olefin from chemical grade olefin. Processes may provide purified olefin streams containing <1000 ppb, <900 ppm, <800 ppb, <700 ppb, <600 ppb, <500 ppb, <400 ppb, <300 ppb, <200 ppb, <100 ppb, <50 ppb, <25 ppb, or <10 ppb CO.

The adsorbent compositions have a high affinity for CO and at the same time are not active towards oxidizing an olefin. For example, ≤1000 ppm, ≤750 ppm, ≤500 ppm, ≤400 ppm, ≤300 ppm, ≤200 ppm, ≤150 ppm, ≤100 ppm, ≤75 ppm, ≤50 ppm, or ≤10 ppm by weight of the olefin is oxidized during an olefin purification method.

In certain embodiments, the contacting, or process stream purification, may be performed at a temperature of from any of about 0° C., about 10° C., about 15° C., about 20° C., about 25° C., about 30° C., about 35° C., about 40° C., about 45° C., about 50° C., about 55° C., or about 60° C. to any of about 65° C., about 70° C., about 75° C., about 80° C., about 85° C., about 90° C., about 95° C., about 100° C., or about 110° C.

In certain embodiments, the process stream purification may be performed at a pressure of from any of about 1 bar, about 2 bar, about 4 bar, about 5 bar, about 7 bar, about 9 bar, about 12 bar, or about 15 bar to any of about 20 bar, about 25 bar, about 30 bar, about 35 bar, about 40 bar, about 45 bar, about 50 bar, about 55 bar, about 60 bar, about 65 bar, about 70 bar, about 75 bar, or about 80 bar.

In certain embodiments, a rate of flow of a gaseous process stream over the adsorbent composition during the contacting is at a gas hourly space velocity (GHSV) from any of about 900 h⁻¹, about 1000 h⁻¹, about 1500 h⁻¹, about 2000 h⁻¹, or about 2500 h⁻¹ to any of about 3000 h⁻¹, about 3500 h⁻¹, about 4000 h⁻¹, about 4500 h⁻¹, about 5000 h⁻¹, or about 5500 h⁻¹.

In certain embodiments, a rate of flow of a liquid process stream over the adsorbent composition during the contacting is at a liquid hourly space velocity (LHSV) of from any of about 0.9 h⁻¹, about 1.0 h⁻¹, about 1.5 h⁻¹, about 2.0 h⁻¹, or about 2.5 h⁻¹ to any of about 3.0 h⁻¹, about 3.5 h⁻¹, about 4.0 h⁻¹, about 4.5 h⁻¹, about 5.0 h⁻¹, about 5.5 h⁻¹, 6.0 h⁻¹, about 6.5 h⁻¹, about 7.0 h⁻¹, about 7.5 h⁻¹, about 8.0 h⁻¹, about 8.5 h⁻¹, about 9.0 h⁻¹, about 9.5 h⁻¹, about 10.0 h⁻¹, or about 10.5 h⁻¹.

In certain embodiments, removal of CO from ethylene is performed in a gas phase and removal of CO from propylene is performed in a liquid phase.

The adsorbent composition may be regenerated after use, for instance by performing a mild re-oxidation. In certain embodiments, the adsorbent composition may be regenerated by treatment with a low concentration of oxygen at a processing temperature, for instance, at about 150° C.

In certain embodiments, the process stream is an olefin stream and ≤1000 ppm, ≤750 ppm, ≤500 ppm, ≤400 ppm, ≤300 ppm, ≤200 ppm, ≤150 ppm, ≤100 ppm, ≤75 ppm, ≤50 ppm, ≤10 ppm, ≤5 ppm, ≤3 ppm, or ≤1 ppm by weight of the olefin is oxidized during the contacting.

In certain embodiments, a CO removal efficiency from the process stream at a contacting temperature of about 30° C., about 40° C., or about 50° C. is ≥1.5 times, ≥2.0 times, ≥2.5 times, ≥3.0 times, ≥3.5 times, ≥4.0 times, ≥4.5 times, ≥5.0 times, ≥5.5 times, or ≥6.0 times that of an adsorbent composition comprising 40 wt % CuO, 40 wt % ZnO, and 19.9 wt % alumina, based on the weight of the composition. The contacting is performed under identical conditions, for example, for an identical process stream at an identical flow rate and identical time, temperature, and pressure, and wherein the adsorbent compositions are in an identical shaped form.

The adsorbent compositions may also be suitable for removing oxygen from a liquid nitrogen stream. In this instance, the compositions are effective towards removing oxygen from a process stream at temperatures down to about 77K.

In certain embodiments, a present adsorbent composition may have a cumulative pore volume of from any of about 0.20 cm³/g, about 0.25 cm³/g, or about 0.30 cm³/g, to any of about 0.35 cm³/g, about 0.40 cm³/g, about 0/45 cm³/g, or about 0.50 cm³/g.

In certain embodiments, the adsorbent compositions may have a N₂ Brunauer-Emmett-Teller (BET) surface area of from any of about 130 m²/g, 140 m²/g, about 145 m²/g, about 150 m²/g, or about 155 m²/g to any of about 160 m²/g, about 165 m²/g, about 170 m²/g, about 175 m²/g, about 180 m²/g, or about 190 m²/g.

In certain embodiments, the adsorbent compositions may have an average pore size of from any of about 20 angstroms, about 25 angstroms, about 30 angstroms, or about 35 angstroms to any of about 40 angstroms, about 45 angstroms, about 50 angstroms, about 55 angstroms, or about 60 angstroms. “Pore size,” as used herein, refers to pore diameter.

### Illustrative Examples

The following examples are set forth to assist in understanding the disclosure and should not, of course, be construed as specifically limiting the embodiments described and claimed herein. Such variations of the embodiments, including the substitution of all equivalents now known or later developed, which would be within the purview of those skilled in the art, and changes in formulation or minor changes in experimental design, are to be considered to fall within the scope of the embodiments incorporated herein.

Sample A: A 199.7 g portion of a copper nitrate solution (17 wt % Cu), 208.3 g of an iron nitrate solution (10 wt % Fe), and 252.5 g of DI (deionized) water is mixed together and heated to 60° C. A 39.5 g portion of CATAPAL® D alumina powder (D50 particle size 40 μm, BET surface area 220 m²/g, pore volume 0.55 mL/g) is dispersed in 127.9 g of DI water using a laboratory blender, and the resulting dispersion is added to the Cu and Fe nitrates. The mixture is diluted with 3000 mL of DI water and subsequently dosed into a reactor. Cu and Fe nitrates are precipitated with addition of about 650 g of sodium carbonate (24 wt % Na₂CO₃) at pH 6.5 and 60° C. for a period of about 1 h. After precipitation is complete, the mixture is allowed to age for an additional 2 hours at 60° C. The solid precipitate is filtered, washed with DI water, and dried overnight at 110° C. Solids are calcined in a muffle furnace at 300° C. for 2 h. The resulting mixed metal oxide media contains 37 wt % CuO, 27 wt % Fe₂O₃, and 36 wt % Al₂O₃.

Sample B: The procedure for Sample A is repeated but instead employing a 199.7 g portion of a copper nitrate solution (17 wt % Cu), 277.3 g of an iron nitrate solution (10 wt % Fe), and 208.2 g of DI water to provide the Cu and Fe nitrates mixture, and a 26 g portion of alumina powder dispersed in 85.3 g of DI water. The resulting mixed metal oxide media contains 39 wt % CuO, 36.9 wt % Fe₂O₃, and 22.5 wt % Al₂O₃.

Sample C: The procedure of Sample A is repeated but instead employing no alumina. A 250 g portion of a copper nitrate solution (17 wt % Cu), a 347.8 g of an iron nitrate solution (10 wt % Fe), and 149.8 g of DI water is employed and is precipitated, aged, filtered, washed, dried, and calcined. The resulting mixed metal oxide media contains 51 wt % CuO and 49 wt % Fe₂O₃.

Sample D: The procedure for Sample A is repeated but instead employing a 194.7 g portion of a copper nitrate solution (17 wt % Cu), a 48.7 g portion of a zinc nitrate solution (16.5 wt % Zn), a 209.5 g portion of an iron nitrate solution (10 wt % Fe), and 241.3 g of DI water to provide a mixed metal nitrate solution, and a 27.6 g portion of alumina powder dispersed in 89.5 g of DI water. The resulting mixed metal oxide media contains 37 wt % CuO, 10 wt % ZnO, 28.8 wt % Fe₂O₃, and 24.2 wt % Al₂O₃.

Samples A, B and C each have a N₂ BET surface area of from 160 m²/g to 170 m²/g, a pore volume of from 0.25 cm³/g to 0.45 cm³/g, and an average pore size of from about 30 angstroms to 50 angstroms.

Prior to testing, powders of Samples A-D are densified with a Carver press and are sieved to a +20/−30 US mesh fraction. Performance for CO removal is evaluated with a plug-flow reactor using about 1 cubic centimeter (cc) of adsorbent. Samples are pre-treated at 150° C. under nitrogen for several hours to remove any moisture, followed by temperature adjustment to the process temperature. Subsequently, 157 ppm CO/N₂ gas in introduced to the reactor at a gas hourly space velocity of 3500 h⁻¹, and effluent gas composition is monitored with a CO analyzer and gas chromatography. CO capacity of a particular sample is defined as the total amount of CO consumed/converted at a time when 5 ppm of CO breaks through. Results for CO capacity (L/kg) at 100° C. and at 30° C. are shown in Table 1. The comparative sample is a commercial adsorbent comprising CuO, ZnO, and alumina and no Fe₂O₃.

TABLE 1

| Sample | CO capacity at 100° C. | CO capacity at 30° C. |
|---|---|---|
| Comparative | 1.9 | 0.9 |
| A | 87.3 | 1.5 |
| B | 107.9 | 2.6 |
| C | 127.4 | 6.2 |
| D | 9.0 | — |

In the foregoing description, numerous specific details are set forth, such as specific materials, dimensions, processes parameters, etc., to provide a thorough understanding of the embodiments of the present disclosure. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the use of the terms “a,” “an,” “the,” and similar referents in the context of describing the materials and methods discussed herein (especially in the context of the following claims) are to be construed to cover both the singular and the plural, unless otherwise indicated herein or clearly contradicted by context.

The term “about” used throughout is used to describe and account for small fluctuations. For instance, “about” may mean the numeric value may be modified by ±5%, ±4%, ±3%, ±2%, ±1%, ±0.5%, ±0.4%, ±0.3%, ±0.2%, ±0.1% or ±0.05%. All numeric values are modified by the term “about” whether or not explicitly indicated. Numeric values modified by the term “about” include the specific identified value. For example “about 5.0” includes 5.0.

The term “essentially no,” “substantially no,” “substantially free,” or the like means “not purposefully added” and only trace or inadvertent amounts may be present, for instance ≤5 wt %, ≤4 wt %, ≤3 wt %, ≤2 wt %, ≤1 wt %, ≤0.5 wt % or ≤0.25 wt %, based on the weight of the composition referred to, for example the total adsorbent composition.

U.S. patents, U.S. patent applications and published U.S. patent applicants discussed herein are hereby incorporated by reference herein in their entireties.

Unless otherwise indicated, all parts and percentages are by weight. Weight percent (wt %), if not otherwise indicated, is based on an entire composition free of any volatiles, that is, based on dry solids content.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Reference throughout this specification to “one embodiment,” “certain embodiments,” “one or more embodiments,” “an embodiment,” or “certain embodiments” means that a particular feature, structure, material, or characteristic described in connection with the embodiment is included in at least one embodiment of the present disclosure. Thus, the appearances of the phrases such as “in one or more embodiments,” “in certain embodiments,” “in one embodiment,” or “in an embodiment” in various places throughout this specification are not necessarily referring to the same embodiment of the present disclosure. Furthermore, the particular features, structures, materials, or characteristics may be combined in any suitable manner in one or more embodiments.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled. The use of any and all examples, or exemplary language (e.g., “such as”) provided herein, is intended merely to better illuminate the materials and methods and does not pose a limitation on the scope unless otherwise claimed. No language in the specification should be construed as indicating any non-claimed element as essential to the practice of the disclosed materials and methods.

Although the embodiments disclosed herein have been described with reference to particular embodiments, it is to be understood that these embodiments are merely illustrative of the principles and applications of the present disclosure. It will be apparent to those skilled in the art that various modifications and variations can be made to the method and apparatus of the present disclosure without departing from the spirit and scope of the disclosure. Thus, it is intended that the present disclosure include modifications and variations that are within the scope of the appended claims and their equivalents, and the above-described embodiments are presented for purposes of illustration and not of limitation.

1. An adsorbent composition capable of removing CO from a process stream at a temperature below 100° C., the composition comprising one or more copper oxides and one or more iron oxides.

2. The composition of claim 1, wherein a weight/weight ratio of the one or more copper oxides to the one or more iron oxides is from about 20/80 to about 80/20.

3. The composition according to claim 1, comprising from about 0.2 wt % to about 99.8 wt % of the one or more copper oxides, based on the total weight of the composition.

4. The composition according to claim 1, comprising from about 0.2 wt % to about 99.8 wt % of the one or more iron oxides, based on the total weight of the composition.

5. The composition according to claim 1 further comprising a support or a filler.

6. The composition according to claim 5, wherein the support or filler is selected from a group consisting of alumina, silica, magnesia, zirconia, aluminosilicates, clays, molecular sieves, activated carbons, and combinations thereof.

7. The composition according to claim 1 further comprising from about 0.1 wt % to about 10.0 wt % ZnO, based on the total weight of the composition.

8. The composition according to claim 1, wherein the composition is essentially free of ZnO.

9. The composition according to claim 1, further comprising one or more promoters selected from a group consisting of potassium, sodium, manganese, chromium, cobalt, tungsten, molybdenum, nickel, magnesium, and calcium.

10. The composition according to claim 9, wherein the one or more promoters are present from about 0.05 wt % to about 5.0 wt %, based on the total weight of the composition.

11. The composition according to claim 1, wherein the composition is in a form selected from a group consisting of tablets, briquettes, rings, stars, wagon wheels, extrudates, rods, cylinders, and pellets.

12. The composition according to claim 1, wherein the composition is in a form selected from a group consisting of tablets, briquettes, cylinders, and pellets, having an average largest diameter from about 1 mm to about 25 mm.

13. The composition according to claim 1, wherein a CO removal efficiency of the composition is ≥1.5 times that of an adsorbent composition comprising 40 wt % CuO, 40 wt % ZnO, and 19.9 wt % alumina when a process stream comprising CO is contacted with the composition at a temperature of about 30° C. under identical conditions.

14. A method of preparation of the composition according to claim 1, the method comprising:
preparing a solution comprising copper salts and iron salts;
precipitating solids from the solution;
isolating and drying the solids; and
calcining the dried solids.

15. The method according to claim 14, further comprising:
subsequently shaping the calcined solids.

16. The method according to claim 14, further comprising:
shaping the dried solids prior to the calcining.

17. The method according to claim 14, further comprising:
subsequently shaping the dried, calcined solids to form shaped solids; and
calcining the shaped solids.

18. The method according to claim 14, wherein the calcining is carried out at a temperature of from about 250° C. to about 700° C., for a time period of from about 0.1 h to about 12 h.

19. The method according to claim 16, wherein the shaping comprises extrusion, tableting, or pelletization.

20. The method according to claim 14, further comprising:
adding a support to the solution comprising the copper salts and the iron salts.

21-30. (canceled)
